(19) United States
(12) Patent Application Publication
(10) Pub. No.: US 2020/0031218 A1
(43) Pub. Date: Jan. 30, 2020

(54) DEVICE FOR SEALING AN AIR INLET OF A MOTOR VEHICLE FRONT FACE

(71) Applicant: Valeo Systemes Thermiques, Le Mesnil-Saint-Denis Cedex (FR)

(72) Inventors: Sylvain Gerber, Le Mesnil Saint-Denis (FR); Enzo Mitidieri, Le Mesnil Saint-Denis (FR)

(73) Assignee: Valeo Systemes Thermiques, Le Mesnil-Saint-Denis Cedex (FR)

(21) Appl. No.: 16/483,642

(22) PCT Filed: Jan. 3, 2018
(86) PCT No.: PCT/FR2018/050011

§ 371 Date: Aug. 5, 2019

(30) Foreign Application Priority Data
Feb. 6, 2017 (FR) 1750962

(51) Int. Cl. B60K 11/08; F16H 21/16

(52) U.S. Cl. CPC B60K 11/085; F16H 21/16

(57) ABSTRACT

The present invention relates to an actuator (9)-lever (11) assembly for a sealing device (1) for a motor vehicle front face air inlet, said assembly comprising:
an actuator (9) comprising two rotary output members (90) having a hollow (91) and each being arranged on a face of said actuator (9) and on the same pivot axis (C), and
in each rotary output member (90), a lever (11) having a stub (110) inserted in the hollow (91) and linked to said rotary output member (90) such as to be driven in rotation by the rotation of said rotary output members (90),
   the hollows (91) of the rotary output members (90) being linked to one another by a communication orifice (92) and the levers (11) being attached to one another through said communication orifice (91).

The present invention relates to sealing devices and more specifically to a device for sealing an air inlet of a motor vehicle front face.

The front faces of motor vehicles usually have two main air inlets, referred to as upper and lower air inlets, that are separated by a fender. The heat exchangers of the motor vehicle are usually positioned behind this fender, such as the heat exchanger used for air conditioning the passenger compartment and/or the heat exchanger used to cool the engine.

It is also known to arrange, in the path of the air passing through the main air inlets, usually the low air inlet, a support frame comprising a plurality of flaps mounted pivotingly about parallel axes and designed to adopt a plurality of different angular positions ranging from an open position to a closed position, under the action of appropriate control means.

This provides a sealing device belonging to a jalousie that makes it possible to adjust the air flow passing through the air inlets and reaching the heat exchangers. This helps to optimize the efficiency of these heat exchangers as a function of requirements and by varying the quantity of air received by the heat exchangers. Furthermore, at high speeds, the flaps in closed position help to reduce the drag coefficient of the vehicle, thereby improving the aerodynamics of said vehicle.

The flaps are moved by a control device notably comprising a control member such as a connecting rod and an actuator. The actuator is usually a motor that transmits a rotational movement to a lever. During rotation, the lever drives the control member in a translational movement that enables the flaps to be closed or opened. In order to limit the zig-zagging of the control member or to move the flaps on both sides of the actuator, the actuator can have two levers arranged on a single axis of rotation and on both sides of the actuator.

Usually, in order to attach the lever to the actuator, the actuator can have a holding device for the lever, such as a direct fastening of the lever to the actuator or via a tab.

However, this type of fastening either requires special handling or dedicated operations during assembly, which increases assembly time and production costs.

One of the objectives of the present invention is therefore to at least partially overcome the drawbacks in the prior art and to propose an actuator-lever assembly and an improved sealing device.

The present invention therefore relates to an actuator-lever assembly for a sealing device for a motor vehicle front face air inlet, said assembly comprising:
an actuator comprising two rotary output members having a hollow and each being arranged on a face of said actuator and on the same pivot axis, and
in each rotary output member, a lever having a stub inserted in the hollow and linked to said rotary output member such as to be driven in rotation by the rotation of said rotary output members,

the hollows of the rotary output members being linked to one another by a communication orifice and the levers being attached to one another through said communication orifice.

Thus, the actuator-lever assembly prevents the flaps from zig-zagging while ensuring minimum assembly time.

According to one aspect of the invention, the rotary output members are arranged on opposite faces of said actuator.

According to one aspect of the invention, the levers are attached to one another by an elastic fitted fastening.

This elastic fitted fastening enables the levers to be easily fastened inside the rotary output members without adding additional fastening steps during the manufacturing method. Accordingly, the levers and the rotary output members need merely be arranged opposite one another.

According to another aspect of the invention, each lever has, at the end of the stub thereof, a flexible tab that is eccentric in relation to the pivot axis and projects into the communication orifice, said tab having, on the face thereof facing the pivot axis, a notch that engages with the notch of the tab of the opposite lever.

According to another aspect of the invention, the tab is integral with the lever.

According to another aspect of the invention, the notch has a first incline oriented away from the stub and a second incline oriented towards said stub, the first incline being less inclined than the second incline.

According to another aspect of the invention, the levers have an appendage extending into the communication orifice and covering the face of said tab opposite the face thereof with the notch.

According to another aspect of the invention, the levers (11) are identical.

The present invention also relates to a device for sealing an air inlet of a motor vehicle front face, including an actuator-lever assembly as described above.

Other features and advantages of the invention will become more clearly apparent on reading the description below, given by way of non-limiting example and the attached drawings, in which:

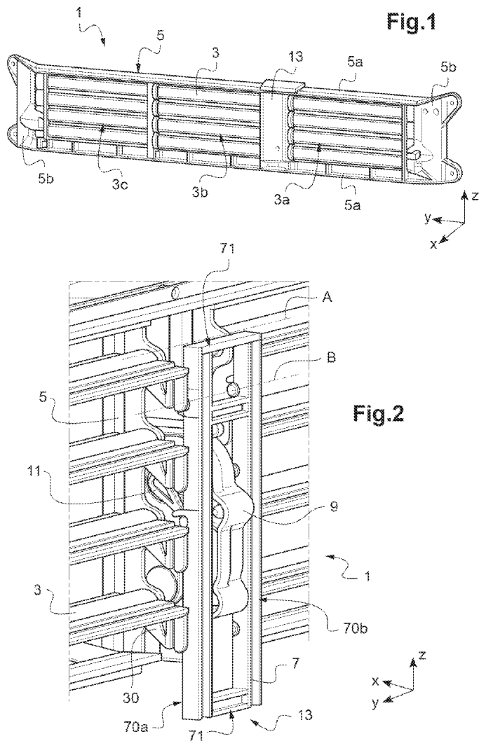

FIG. 1 is a schematic perspective front view of a sealing device in closed position,

FIG. 2 is a schematic perspective view of a control element,

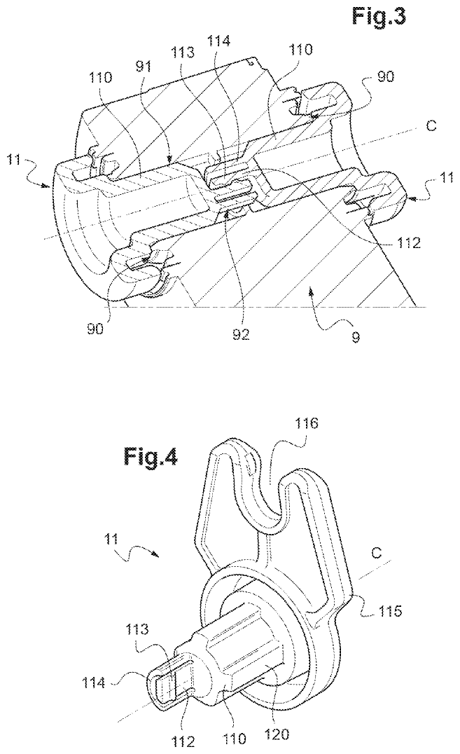

FIG. 3 is a schematic perspective cross section view of an actuator-lever assembly,

FIG. 4 is a schematic perspective view of a lever,

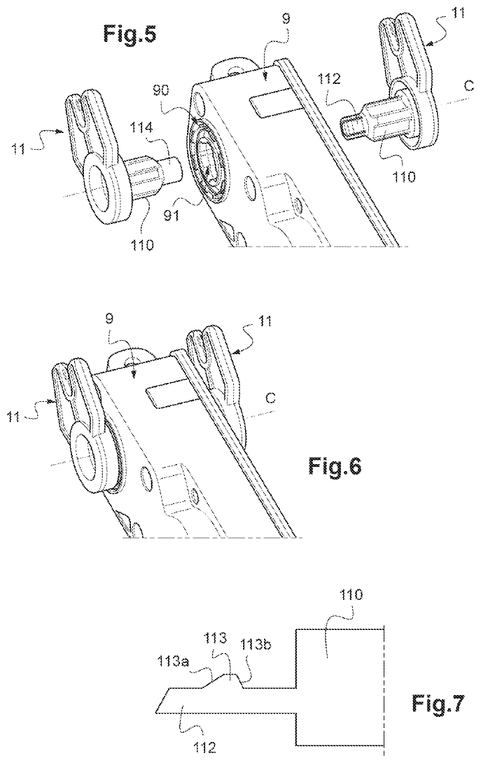

FIG. 5 is a schematic perspective view of an actuator-lever assembly during a first step of the assembly method,

FIG. 6 is a schematic perspective view of an actuator-lever assembly during a second step of the assembly method,

FIG. 7 is a schematic side view of a tab of the lever in FIG. 4.

Identical elements in different figures are identified using the same reference signs.

The following embodiments are examples. Although the description refers to one or more embodiments, this does not necessarily mean that each reference sign refers to the same embodiment, or that the features apply only to one embodiment. Individual features of different embodiments may also be combined or swapped to provide other embodiments.

In the present description, certain elements or parameters may be numbered, for example first element or second element, or first parameter and second parameter, or first criterion and second criterion, etc. In this case, such numbering is merely intended to differentiate and describe elements, parameters or criteria that are similar but not identical. This numbering does not imply priority of one element, parameter or criterion over another, and as such descriptions can be simply interchanged without thereby moving outside the scope of the present description. Furthermore, this numbering does not imply any chronological order, for example when assessing criteria.

An axis system XYZ is used in FIGS. 1 and 2 to show the viewing angle of each of said figures in relation to one another. The axes of this system can also relate to the different orientations of the motor vehicle. The axis X can be the length of the vehicle, the axis Y can be the width of the vehicle and the axis Z can be the height of the vehicle.

FIG. 1 is a schematic perspective view of a sealing device 1 in closed position. More precisely, FIG. 1 shows the outer face of the sealing device 1, i.e. the face oriented towards the outside of the motor vehicle when the sealing device 1 is assembled on the vehicle.

The sealing device 1 has a support frame 5 including notably two longitudinal cross members 5a extending parallel to the axis Y of the axis system, and at least two side pillars 5b extending parallel to the axis Z of the axis system and linking the longitudinal cross members 5a. The support frame 5 is for example made of plastic. The two longitudinal cross members 5a and the at least two side pillars 5b are thus molded. The support frame 5 can be molded as a single part in order to improve the rigidity thereof.

A plurality of flaps 3 is installed inside the support frame 5 to form rows of flaps 3 parallel with one another, forming at least a first set 3a and a second set 3b of flaps 3. A control element 13 is arranged between this first set 3a and second set 3b of flaps 3 to control the rotation of the flap or flaps 3 about a pivot axis A between an open position (shown in FIG. 2) in which the flaps 3 are positioned such that an air flow can pass through the sealing device 1, notably into the support frame 5, and a closed position shown in FIG. 1, in which the flaps 3 are positioned such that an air flow cannot pass through the sealing device 1.

More specifically, FIG. 1 shows a sealing device 1 with three sets 3a, 3b and 3c of flaps 3.

As shown in FIG. 2, the control element 13 notably includes a control member 7. Each flap 3 has a control arm 30 perpendicular to the pivot axis A thereof and having a link axis B enabling said control arm 30 to be linked to the control device 7. The pivot axis A and the link axes B are all parallel to the axis Y of the axis system. The control arm 30 is usually made from the material of the flaps 3.

As shown in FIG. 2, the control member 7 can be made as a single part comprising two connecting rods 70a, 70b. Said connecting rods 70a, 70b are linked together by at least one spacer cross member 71, preferably by a spacer cross member 71 at each end of the connecting rods 70a, 70b. Such a control member 7 is rigid and enables good synchronization of the movements of the sets 3a, 3b of flaps 3.

Each flap 3 can pivot about the pivot axis A thereof defined by the link between said flap and the support frame 5. The link axes B between the flaps 3 and the control member 7 are eccentric in relation to the pivot axes A such that a translational movement parallel to the axis Z of the axis system of the control member 7, under the action of the actuator 9, pivots the flaps 3 about the respective pivot axes A thereof, thereby causing said flaps 3 to move from one position to another.

Since all of the flaps 3 are linked to the same control member 7, all of the flaps 3 move from an open position to a closed position synchronously.

During translational movement along the axis Z of the axis system of the control member 7, a shifting movement of said control member 7 along the axis X of the axis system can be observed. This is caused by the rotation of the control arms 30 about the pivot axes A that forms a circular arc.

The control element 13 usually includes an actuator 9. The actuator 9 can be electric, for example an electric motor. The actuator 9 applies a translational movement to the control member 7 by means of two levers 11. This translational movement occurs along the axis Z of the axis system.

FIG. 3 shows a cross section of an actuator 9-lever 11 assembly according to the invention taken at the link between the actuator 9 and the levers 11. The actuator 9 has two rotary output members 90, each of which has a hollow 91. These rotary output members 90 are each arranged on a different surface of said actuator 9 and have the same pivot axis C. A lever 11 is inserted in each rotary output member 90. The hollows 91 in the rotary output members 90 are linked to one another via a communication orifice 92 inside the actuator 9.

The levers 11 each have a stub 110 inserted into a hollow 91 of a rotary output member 90. The hollows 91 and the stub 110 have matching shapes such that the lever 11 is driven in rotation by the rotation of the rotary output member 90. The stub 110 can for example be square, or have one or more splines 120 (shown in FIG. 4).

As shown in FIG. 4, the lever 11 notably includes a lever arm 115. At one of the ends of the lever arm 115, the stub 11 projects perpendicular to said lever arm 115. At the other end of the lever arm 115, the lever 11 has a connection device 116 to the control member 7, in this case an oblong slot in which a connection pin of the control member 7 is designed to be inserted.

The levers 11 are fastened to one another through said communication orifice 91 by means of an elastic fitted fastening, as shown in FIG. 3. The communication orifice 91 is dimensioned such that the elastic fitted fastening can pivot therein at the same time as the levers 11 pivot. This elastic fitted fastening enables the levers 11 to be easily attached inside the rotary output members 90 without adding additional fastening steps during the manufacturing method. Accordingly, the levers 11 and the rotary output members 90 need merely be arranged opposite one another, as shown in FIG. 5. More specifically, the stubs 110 need simply be aligned on the pivot axis C and inserted in the hollows 91, as shown in FIG. 6.

The elastic fitted fastening between the levers 11 can notably include a flexible tab 112 extending from the stub 110. This tab 112 is eccentric in relation to the pivot axis C and extends into the communication orifice 92. The tab 112 has a notch 113 on the face thereof facing the pivot axis C that engages with the notch 113 of the tab 112 of the opposing lever 11. The tab 112 can notably be integral with the lever 11. This embodiment can notably have two identical levers 11 and can therefore be formed as a single manufacturing process, for example using a single mold into which the plastic material is injected. The fact of having identical levers 11 that can be made in a single mold enables production savings and also obviates the need to distinguish between different levers 11 to ensure the correct positioning thereof. This simplifies the manufacturing and assembly process.

The levers 11 can also have, at the end of the stub 110 thereof, an appendage 114 extending into the communication orifice 92 and covering the face of said tab 112 opposite the face thereof with the notch 113. This appendage 114 helps to protect the tab 112 and is also used as poka-yoke to position and align the levers 11 correctly in relation to one another. As shown in FIG. 4, this appendage 114 can be hemispherical and integral with the lever 11, like the tab 112.

As shown in FIG. 7, the notch 113 can more specifically have a first incline 113a oriented away from the stub 110 and a second incline 113b oriented towards said stub 110. To enable a reversible elastic fastening, the first incline 113a can notably have a lesser incline than the second incline 113b. This difference in incline enables the notches 113 to be easily brought together, while requiring a greater force to release the connection between the levers 11.

Thus, it can be seen how the actuator 9-lever 11 assembly enables the levers 11 to be easily attached to one another without having to perform complex or additional handling actions during the assembly method of the sealing device 1.

1. An actuator-lever assembly for a sealing device for a motor vehicle front face air inlet, said assembly comprising:
an actuator comprising two rotary output members each having a hollow and being arranged on a face of said actuator and on the same pivot axis; and
in each of the two rotary output members, a lever having a stub inserted in the hollow and linked to said rotary output member such as to be driven in rotation by rotation of said two rotary output members;
wherein the hollows of the two rotary output members are linked to one another by a communication orifice and the levers are attached to one another through said communication orifice.

2. The actuator-lever assembly as claimed in claim 1, in which the two rotary output members are arranged on opposite faces of said actuator.

3. The actuator-lever assembly as claimed in claim 1, in which the levers are attached to one another by an elastic fitted fastening.

4. The actuator-lever assembly as claimed in claim 1, wherein each lever has, at the end of the stub thereof, a flexible tab that is eccentric in relation to the pivot axis and projects into the communication orifice, said tab having, on the face thereof facing the pivot axis, a notch that engages with the notch of the tab of the opposite lever.

5. The actuator-lever assembly as claimed in claim 4, wherein the tab is integral with the lever.

6. The actuator-lever assembly as claimed in claim 4, wherein the notch has a first incline oriented away from the stub and a second incline oriented towards said stub, the first incline being less inclined than the second incline.

7. The actuator-lever assembly as claimed in claim 4, wherein the levers have an appendage extending into the communication orifice and covering the face of said tab opposite the face thereof with the notch.

8. The actuator-lever assembly as claimed in claim 1, wherein the levers are identical.

9. A device for sealing an air inlet of a motor vehicle front face, including:
an actuator-lever assembly comprising:
an actuator comprising two rotary output members each having a hollow and being arranged on a face of said actuator and on the same pivot axis; and
in each of the two rotary output members, a lever having a stub-inserted in the hollow and linked to said rotary output member such as to be driven in rotation by rotation of said two rotary output members,
wherein the hollows of the two rotary output members are linked to one another by a communication orifice and the levers are attached to one another through said communication orifice.
